(19) United States
(12) Patent Application Publication
(10) Pub. No.: US 2025/0197970 A1
(43) Pub. Date: Jun. 19, 2025

(54) LEAD-FREE BRASS ALLOY AND BEARING COMPONENT PRODUCED THEREFROM

(71) Applicants: Diehl Brass Solutions Stiftung & Co. KG, Röthenbach (DE); VDM Metals International GmbH, Werdohl (DE)

(72) Inventors: Volker Bräutigam, Erlangen (DE); Alexander Dehnelt, Nürnberg (DE); Sven Reimus, Flörsheim (DE); Miroslava Sakaliyska, Frankfurt am Main (DE); Florian Seuss, Spardorf (DE); Patrick Feldner, Nürnberg (DE)

(21) Appl. No.: 19/069,296

(22) Filed: Mar. 4, 2025

Related U.S. Application Data
(63) Continuation of application No. PCT/EP2023/074001, filed on Sep. 1, 2023.

(30) Foreign Application Priority Data
Sep. 8, 2022 (DE) 10 2022 122 830.4

(51) Int. Cl. C22C 9/04

(52) U.S. Cl. CPC C22C 9/04

(57) ABSTRACT

A lead-free brass alloy contains 59 to 62 wt % of Cu, 2.0 to 2.5 wt % of Mn, 0.5 to 1.5 wt % of Si, less than 0.1 wt % of Pb, and a remainder or balance of Zn as well as unavoidable impurities. A bearing element or a bushing produced from the lead-free brass alloy is also provided.

### CROSS-REFERENCE TO RELATED APPLICATION

This application is a continuation, under 35 U.S.C. § 120, of copending International Patent Application PCT/EP2023/074001, filed Sep. 1, 2023, which designated the United States; this application also claims the priority, under 35 U.S.C. § 119, of German Patent Application DE 10 2022 122 830.4, filed Sep. 8, 2022; the prior applications are herewith incorporated by reference in their entirety.

### FIELD AND BACKGROUND OF THE INVENTION

The invention relates to a lead-free brass alloy.

In the past, the machining of brass alloys was improved by the addition of Pb to an extent of up to 4 wt %. For the future, however, there are severe limitations on the addition of Pb, due to foreseeable statutory stipulations.

There is therefore a demand for a lead-free brass alloy. Alloys of that kind are known per se; reference is made, for example, to the following publications: European Patent Application EP 2 009 122 A1, corresponding to U.S. Publication No. 2009/0022620 A1; European Patent Application EP 3 272 888 A1; International Publication WO 2016/045770 A1, corresponding to U.S. Publication No. 2017/0204501 A1; and European Patent Application EP 3 269 835 A1, corresponding to U.S. Patent No. 10,316,398 B2. The absence of lead, however, is detrimental to the machinability of such brass alloys.

### SUMMARY OF THE INVENTION

It is accordingly an object of the invention to provide a lead-free brass alloy and a bearing component produced therefrom, which overcome the hereinafore-mentioned disadvantages of the heretofore-known alloys and components of this general type and in which the lead-free brass alloy has good machinability and possesses good frictional wear resistance.

With the foregoing and other objects in view there is provided, in accordance with the invention, a lead-free brass alloy containing: 59 to 62 wt % of Cu, 2.0 to 2.5 wt % of Mn, 0.5 to 1.5 wt % of Si, less than 0.1 wt % of Pb, a remainder of Zn and unavoidable impurities.

The brass alloy of the invention possesses less than 0.1 wt % of Pb and is therefore deemed to be lead-free. It has emerged that in spite of the low lead content of less than 0.1 wt %, the brass alloy of the invention exhibits satisfactory machinability. In particular, machining is not accompanied by the formation of any unwanted long spiral chips. Furthermore, the frictional properties of the lead-free brass alloy of the invention are comparable with those of a lead-containing brass alloy.

In one advantageous configuration of the invention, the ratio of the weight percentages of Mn to Si corresponds to the inequation 2.2≤Mn/Si≤3.2. It has been found that this ratio between manganese and silicon leads to an optimal chemical composition and to the formation of manganese silicides.

In the lead-free brass alloy of the invention, a parallel arrangement of manganese silicides on a functional face is particularly preferred. This increases the proportion of the manganese silicides at the functional face, and the frictional properties are improved. The parallel arrangement of the manganese silicides is achieved through a production process that includes a hot forming operation.

In the lead-free brass alloy of the invention there is preferably less than 0.1 wt % of Fe, preferably 0.07 wt % of Fe.

In the lead-free brass alloy of the invention there is preferably less than 0.5 wt % of Sn, preferably 0.07 wt % of Sn.

The following composition of the lead-free brass alloy of the invention is particularly preferred: 61.2 wt % of Cu, 2.3 wt % of Mn, 0.8 wt % of Si, 0.07 wt % of Fe, 0.07 wt % of Sn, less than 0.1 wt % of Pb, remainder Zn and also unavoidable impurities.

In the lead-free brass alloy of the invention there is preferably less than 0.2 wt % of Ni, more preferably 0.02 wt % to less than 0.2 wt % of Ni.

In one preferred configuration of the invention, the lead-free brass alloy contains less than 0.1 wt % of Al, preferably 0.01 wt % to less than 0.1 wt % of Al.

In the lead-free brass alloy, it may also be the case that there is less than 0.25 wt % of Cr and/or less than 0.25 wt of Ti and/or less than 0.25 wt % of Co.

With the objects of the invention in view, there is concomitantly provided a bearing element or a bushing produced from the lead-free brass alloy of the invention. Due to its good frictional properties, the lead-free brass alloy is ideally suited to the production of bearing elements and bushings.

Other features which are considered as characteristic for the invention are set forth in the appended claims.

Although the invention is illustrated and described herein as embodied in a lead-free brass alloy and a bearing component produced therefrom, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, plan view showing a functional face of a lead-free brass alloy of the invention;

FIG. 2 is a plan view showing a chip pattern generated by machining a reference alloy; and

FIG. 3 is a plan view showing a chip pattern generated by machining a lead-free brass alloy of the invention.

### DETAILED DESCRIPTION OF THE INVENTION

Referring now to the diagrammatic figures of the drawings in detail, it is seen that one exemplary embodiment of the lead-free brass alloy has the following composition: 61.2 wt % of Cu, 2.3 wt % of Mn, 0.8 wt % of Si, 0.07 wt % of Fe, 0.07 wt % of Sn, less than 0.1 wt % of Pb, a remainder Zn and also unavoidable impurities.

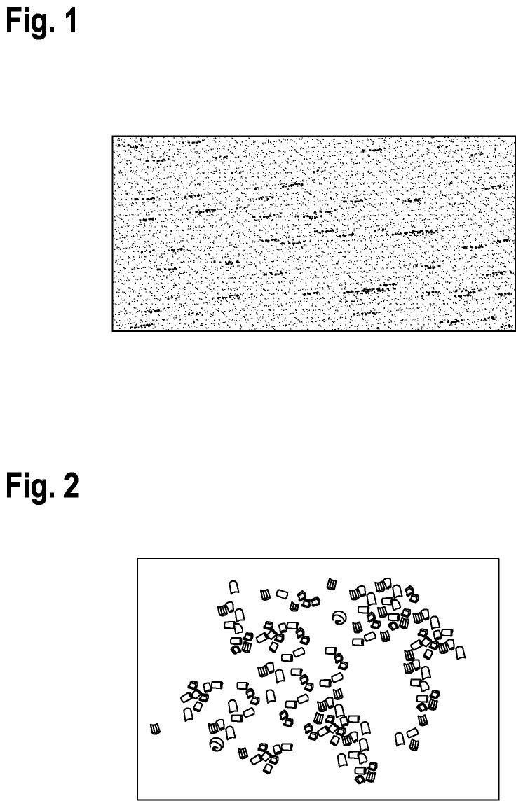

The lead-free brass alloy can be processed into intermediates such as plates, tubes or rods, from which components such as bearing elements, bushings or the like can then be produced. FIG. 1 shows a functional face of an intermediate produced from the lead-free brass alloy. It is apparent that there are manganese silicides disposed in parallel on the functional face. The comparatively high proportion of the manganese silicides on the functional face improves its frictional properties.

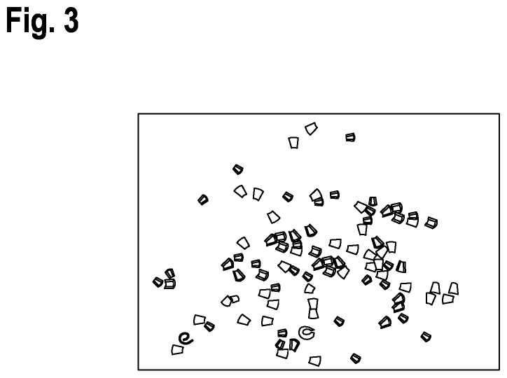

The machinability of the lead-free brass alloy is compared with a reference alloy. In the table below, the compositions of the lead-free brass alloy and of the reference alloy are set out:

| Lead-free brass alloy | | Reference alloy | |
|---|---|---|---|
| (chip pattern FIG. 2) | | (chip pattern FIG. 3) | |
| 61.2 | wt % Cu, | 61.4 | wt % Cu, |
| 2.3 | wt % Mn, | 2.3 | wt % Mn, |
| 0.8 | wt % Si, | 0.8 | wt % Si, |
| 0.07 | wt % Fe, | 0 | wt % Fe, |
| 0.07 | wt % Sn, | 0 | wt % Sn, |
| <0.1 | wt % Pb, | 0.7 | wt % Pb. |

A machining trial was carried out using an indexable cutting insert of type CNMG120404FP HC5010, with a rotary speed of 3000 rpm, an advancement per rotation of 0.25 mm and a cutting depth of 1.25 mm. FIG. 2 shows the chip pattern of the lead-free brass alloy; FIG. 3 shows, in comparison to this, the chip pattern of the lead-containing reference alloy. It is apparent that the two alloys generate chips of approximately the same size and kind. The chip quality of the lead-free brass alloy is therefore satisfactory. For the two alloys, the surface roughnesses were measured. They were for the lead-free brass alloy Ra=5.32 μm and for the reference alloy Ra=5.61 μm. The lead-free brass alloy therefore has a surface roughness comparable to that of the lead-containing reference alloy.

For the two alloys, the friction coefficient was ascertained in identical trials. It was discovered that both the lead-free brass alloy and the lead-containing reference alloy possess virtually identical friction coefficients. The friction coefficient is about 0.012.

These trials showed that the lead-free brass alloy can be used without limitations as a replacement for the lead-containing reference alloy.

The lead-free brass alloy can be used for example for producing bearing elements, bushings or other components for which there is a relative movement between two components.

1. A lead-free brass alloy, comprising:
59 to 62 wt % of Cu;
2. 0 to 2.5 wt % of Mn;
0. 5 to 1.5 wt % of Si;
<0.1 wt % of Pb; and
a remainder of Zn and unavoidable impurities.

2. The lead-free brass alloy according to claim 1, wherein a ratio of the weight percentages of Mn to Si corresponds to the following inequation:
2.2≤Mn/Si≤3.2.

3. The lead-free brass alloy according to claim 1, which further comprises manganese silicides disposed in parallel on a functional face.

4. The lead-free brass alloy according to claim 1, which further comprises less than 0.1 wt % of Fe.

5. The lead-free brass alloy according to claim 1, which further comprises 0.07 wt % of Fe.

6. The lead-free brass alloy according to claim 1, which further comprises less than 0.5 wt % of Sn.

7. The lead-free brass alloy according to claim 1, which further comprises 0.07 wt % of Sn.

8. The lead-free brass alloy according to claim 1, which further comprises:
61.2 wt % of Cu;
2. 3 wt % of Mn;
0. 8 wt % of Si;
0. 07 wt % of Fe;
0. 07 wt % of Sn;
<0.1 wt % of Pb; and
a remainder Zn and unavoidable impurities.

9. The lead-free brass alloy according to claim 1, which further comprises less than 0.2 wt % of Ni.

10. The lead-free brass alloy according to claim 1, which further comprises from 0.02 wt % to less than 0.2 wt % of Ni.

11. The lead-free brass alloy according to claim 1, which further comprises less than 0.1 wt % of Al.

12. The lead-free brass alloy according to claim 1, which further comprises from 0.01 wt % to less than 0.1 wt % of Al.

13. The lead-free brass alloy according to claim 1, which further comprises at least one of:
less than 0.25 wt % of Cr, or
less than 0.25 wt % of Ti. or
less than 0.25 wt % of Co.

14. A bearing element or bushing, comprising the lead-free brass alloy according to claim 1.
